(19) United States
(12) Patent Application Publication
(10) Pub. No.: US 2024/0295329 A1
(43) Pub. Date: Sep. 5, 2024

(54) DEVICE FOR CONTROLLING SET HEATING TEMPERATURE, HEATING SYSTEM, AND METHOD FOR DETERMINING INSULATION RATING THEREOF

(71) Applicant: KYUNGDONG NAVIEN CO., LTD., Pyeongtaek-si, Gyeonggi-do (KR)

(72) Inventors: Chang Heoi Heo, Seoul (KR); Yong Min Song, Seoul (KR); Soon Ki Kim, Seoul (KR); Jung Keom Kim, Seoul (KR); Jun Young Kim, Seoul (KR)

(21) Appl. No.: 18/568,095

(22) PCT Filed: Jun. 14, 2022
(86) PCT No.: PCT/KR2022/008393

§ 371 Date: Dec. 7, 2023

(30) Foreign Application Priority Data
Sep. 24, 2021 (KR) 10-2021-0126527
Oct. 8, 2021 (KR) 10-2021-0133851

(51) Int. Cl. F24D 19/10; G01N 25/18

(52) U.S. Cl. CPC F24D 19/10; G01N 25/18; F24D 2220/042

(57) ABSTRACT

A heating system, according to one embodiment of the present invention, comprises: a heater for heating the entirety of an indoor space or a predetermined indoor space; an indoor temperature controller for controlling a heating operation of the heater; and a server for determining an insulation rating of a building in which the heater is installed, on the basis of indoor temperature data received from the heater or the indoor temperature controller.

### TECHNICAL FIELD

The present disclosure relates to a device for controlling a set heating temperature, a heating system, and a method for determining an insulation rating thereof.

### BACKGROUND ART

Buildings such as apartments, officetels, villas, and single-family homes are equipped with heaters such as boilers for indoor heating. The insulation status of such buildings may vary depending on structural differences, and the insulation status is directly related to energy savings and heating demand when heating through heaters.

In other words, when the insulation status of the building is known in advance, it is possible to adjust the heating demand from the heater according to the insulation status, thereby increasing heating efficiency and saving energy.

In general, the insulation rating of a building is determined based on the thermal transmittance value of the interior and exterior materials used in constructing the building. As described above, because the insulation rating is conventionally identified only with the materials used in the building, there may be differences from the insulation rating checked during the actual heating process.

In addition, it is not easy to determine the insulation rating of a building or obtain data on a predetermined insulation rating when controlling heating, so it is not easy to apply the insulation rating when controlling heating.

In addition, when controlling heating in a building where a heater is installed, the heating efficiency may vary greatly depending on the insulation status of the building. However, a conventional scheme of controlling a set heating temperature only reflects changes in outdoor temperature in controlling the set heating temperature and does not take into account the insulation status of the building at all.

### DISCLOSURE

### Technical Problem

An aspect of the present disclosure provides a heating system and a method for determining an insulation rating capable of determining the insulation rating of an actual building based on changes in temperature data obtained during heating control.

In addition, another aspect of the present disclosure provides a heating system and a method for determining an insulation rating capable of determining the insulation rating of an actual building based on the number of times a heater is turned on/off while controlling the heating based on a set temperature.

In addition, another aspect of the present disclosure provides a heating system and a method for determining an insulation rating capable of obtaining information about the insulation rating of a building where the heater is installed from a server, and reflecting the obtained insulation rating information of the building and changes in outdoor temperature in controlling a set heating temperature, thereby performing optimized heating control.

The technical problems to be solved by the present disclosure are not limited to the aforementioned problems, and any other technical problems not mentioned herein will be clearly understood from the following description by those skilled in the art to which the present disclosure pertains.

### Technical Solution

According to an aspect of the present disclosure, a heating system includes a heater that heats an entire or specified indoor space, an indoor temperature controller that controls a heating operation of the heater, and a server that determines an insulation rating of a building in which the heater is installed, based on indoor temperature data received from the indoor temperature controller or the heater.

The server may receive and store indoor temperature data every specified time period when the heater is turned off after being operated for a first time period.

The server may store external environment information at a corresponding time point when the stored indoor temperature data reaches a predetermined number.

The server may store information about a time taken for an indoor temperature to decrease by a reference temperature based on a highest indoor temperature among the indoor temperature data when the stored indoor temperature data reaches a specified number.

The server may classify information about a time taken for a same indoor temperature to decrease by the reference temperature based on a same outdoor temperature for each heater, and determine an insulation rating of a building in which a corresponding heater is installed, based on a classified decreasing time of an indoor temperature for each heater.

The server may determine the insulation rating to be higher as the time taken for the indoor temperature to decrease by the reference temperature increases.

The server may determine the insulation rating of the building in which the corresponding heater is installed after relatively evaluating the time taken for the indoor temperature to decrease by the reference temperature based on an insulation rating corresponding to an initially registered heater.

The heater may enter an auxiliary insulation rating determination mode when there is no change in indoor set temperature during a reference time in an indoor temperature mode.

The server may count a number of times the heater turned on/off during a second time period when the heater enters the auxiliary insulation rating determination mode, and determine the insulation rating of the building in which the heater is installed based on the number of times the heater is turned on/off during the second time period.

The server may determine the insulation rating of the building in which the heater is installed to be higher as the number of on/off times of the heater counted during the second time decreases.

The server may store information on the insulation rating determined for the building where the heater is installed and provide the information on the insulation rating for the building when requested.

According to another aspect of the present disclosure, a method of determining an insulation rating of a heating system includes receiving, by a server, indoor temperature data every specified time period from a heater configured to heat an entire or specified indoor space or an indoor temperature controller configured to control a heating operation of the heater, and determining, by the server, an insulation rating of a building in which the heater is installed, based on the indoor temperature data received every specified time period.

The determining of the insulation rating may include storing information about a time taken for an indoor temperature to decrease by a reference temperature based on a highest indoor temperature among the indoor temperature data when the indoor temperature data reaches a specified number, classifying information about a time taken for a same indoor temperature to decrease by the reference temperature based on a same outdoor temperature for each heater, and determining an insulation rating of a building in which a corresponding heater is installed, based on a classified decreasing time of an indoor temperature for each heater.

The method may further include entering, by the heater, an auxiliary insulation rating determination mode when there is no change in indoor set temperature during the reference time in an indoor temperature mode.

The method may further include counting a number of times the heater turned on/off during a second time period when the heater enters the auxiliary insulation rating determination mode, and determining the insulation rating of the building in which the heater is installed based on the number of times the heater is turned on/off during the second time period.

According to still another aspect of the present disclosure, a device for controlling a set heating temperature includes a controller that determines a temperature setting factor value based on insulation rating information received from a server that manages the insulation rating information of a building in which a heater is installed, and a temperature setting device that determines the set heating temperature corresponding to an outdoor temperature based on the determined temperature setting factor value.

The controller may determine the temperature setting factor value based on a default value of the temperature setting factor, a predefined reference insulation rating, and an insulation rating of a corresponding building.

The controller may determine the temperature setting factor value based on a value obtained by subtracting the insulation rating of the building from the reference insulation rating when the insulation rating of the building is lower than or equal to the reference insulation rating, and determine the temperature setting factor value based on a value obtained by subtracting the reference insulation rating from the insulation rating of the building when the insulation rating of the building is higher than the reference insulation rating.

The temperature setting device may determine the set heating temperature corresponding to the outdoor temperature based on a temperature change graph defined corresponding to the determined temperature setting factor value.

The device may further include a communication device that transmits the determined set heating temperature to an indoor temperature controller installed in an indoor space where a user is located.

The device may further include storage configured to store the insulation rating information received from a server that manages the insulation rating information for the building in which the heater is installed.

### Advantageous Effects

According to the present disclosure, the actual insulation rating of a building may be determined based on changes in temperature data obtained during heating control.

In addition, according to the present disclosure, the actual insulation rating of a building may be determined based on the number of times the heater is turned on/off while heating is controlled based on a set temperature.

In addition, according to the present disclosure, by determining the actual insulation rating of a building and converting the insulation rating into data, the insulation rating data may be utilized for heating control.

In addition, according to the present disclosure, information on the insulation rating of a building where the heater is installed may be obtained from a server, and the obtained insulation rating information of the building and changes in outdoor temperature may be reflected in controlling a set heating temperature, thereby performing optimized heating control.

### DESCRIPTION OF DRAWINGS

FIG. 1 is a block diagram illustrating a heating system according to an embodiment of the present disclosure.

FIG. 2 is a block diagram illustrating a heating system according to another embodiment of the present disclosure.

FIGS. 3 and 4 are flowcharts illustrating a method for determining the insulation rating of a heating system according to an embodiment of the present disclosure.

FIGS. 5 and 6 are flowcharts illustrating a method for determining an insulation rating of a heating system according to another embodiment of the present disclosure.

FIG. 7 is a block diagram illustrating the configuration of a device for controlling a set heating temperature according to an embodiment of the present disclosure.

FIGS. 8 to 10 are diagrams illustrating an embodiment referred to in explaining the operation of a device controlling a set heating temperature according to an embodiment of the present disclosure.

FIG. 11 is a flowchart illustrating a method for controlling a set heating temperature according to an embodiment of the present disclosure.

### MODE FOR INVENTION

Hereinafter, some embodiments of the present disclosure will be described in detail with reference to the exemplary drawings. In adding the reference numerals to the components of each drawing, it should be noted that the identical or equivalent component is specified by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

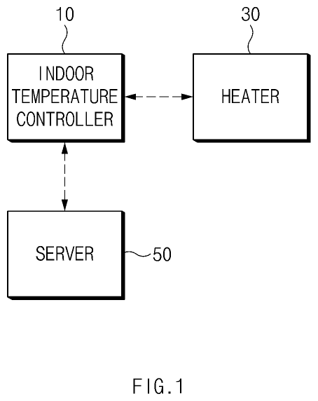

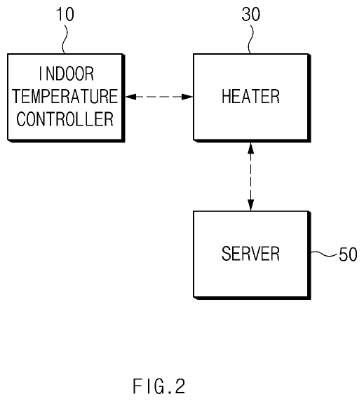

FIG. 1 is a block diagram illustrating a heating system according to an embodiment of the present disclosure. FIG. 2 is a block diagram illustrating a heating system according to another embodiment of the present disclosure.

Referring to FIGS. 1 and 2, a heating system may include an indoor temperature controller 10, a heater 30, and a server 50.

The indoor temperature controller 10 is connected to the heater 30 and controls the overall operation of the heater 30.

First, the indoor temperature controller 10 may transmit a power on/off control signal to the heater 30. In addition, when a set heating temperature for heating operation is input from a user, the indoor temperature controller 10 may control the ON/OFF operation of the heater 30 based on the input set heating temperature.

In this case, the indoor temperature controller 10 may detect the temperature or humidity of the room where a controller terminal is installed, and transmit a control signal for controlling the ON/OFF operation of the heater 30 according to the detected indoor temperature.

In addition, the indoor temperature controller 10 may receive information detected by sensors of the heater 30 while the heater 30 performs heating, and based on the received sensor detection information, control the operation of the heater 30. For example, the indoor temperature controller 10 may transmit a control signal for controlling the ON/OFF operation of the heater 30 to the heater 30 according to a supply water temperature, a return water temperature, and the like. In addition, the indoor temperature controller 10 may transmit a control signal for controlling the ON/OFF operation of the heater 30 to the heater 30, depending on whether an overheating preventer of the heater 30 operates.

According to an embodiment, one or more indoor temperature controllers 10 may be provided, and each indoor temperature controller 10 may be installed in different indoor spaces within the building.

Referring to FIG. 1, the indoor temperature controller 10 may be connected to the server 50 for communication. In this case, the heater 30 may not be connected to the server 50 for communication.

In this case, when the heating operation of the heater 30 is turned on or off, the indoor temperature controller 10 may transmit an ON or OFF signal of the heater 30 to the server 50.

In addition, when the heating operation of the heater 30 is turned off, the indoor temperature controller 10 may measure and store the indoor temperature at that time, and may transmit the stored indoor temperature data to the server 50. In this case, the indoor temperature controller 10 may measure the indoor temperature every specified time period before the heating operation of the heater 30 is turned on again after being turned off, and transmit it to the server 50.

When there is no change in the indoor set temperature during a reference time while the heater 30 operates in an indoor temperature mode in which the heater 30 operates based on the indoor set temperature, the indoor temperature controller 10 may enter an auxiliary insulation rating determination mode and operate in the auxiliary insulation rating determination mode. In this case, the indoor temperature controller 10 may transmit a signal notifying entry into the auxiliary insulation rating determination mode to the server 50.

The heater 30 shown in FIGS. 1 and 2 may receive control signals through communication with the indoor temperature controller 10. In this case, the heater 30 performs a heating operation for the building in which the heater 30 is installed based on the control signal received from the indoor temperature controller 10.

As an example, the heater 30 may include a boiler. Boilers are classified into oil boilers, gas boilers, and the like depending on the type of fuel. A boiler may burn fuel to raise the temperature of heating water, and supply the heated water through pipes to heat the entire building or a specific space.

While performing a heating operation, the heater 30 may detect the supply water temperature, return water temperature, hot water temperature, direct water temperature, and the like and transmit them to the indoor temperature controller 10. In addition, the heater 30 may transmit, to the indoor temperature controller 10, an operation state of the overheating preventer for preventing overheating of the heater 30 while performing a heating operation.

Referring to FIG. 2, the heater 30 may be connected to the server 50 for communication. In this case, the indoor temperature controller 10 may not be separately connected to the server 50 for communication.

In this case, when the heating operation of the heater 30 is turned on or off by the indoor temperature controller 10, the heater 30 may transmit an ON or OFF signal to the server 50.

In addition, when the heating operation is turned off, the heater 30 may store the indoor temperature at the corresponding time point and transmit the stored indoor temperature data to the server 50. In this case, the heater 30 may transmit, to the server 50, the indoor temperature data measured every specified time period unit after the heating operation is turned off until it is turned on again.

When the heater 30 operates in an indoor temperature mode in which the heater 30 operates based on the indoor set temperature, and there is no change in the indoor set temperature during a reference time period, the heater 30 may operate in the auxiliary insulation rating determination mode according to a control signal from the indoor temperature controller 10. In this case, the heater 30 may transmit a signal notifying entry into the auxiliary insulation rating determination mode to the server 50.

As described in the embodiment of FIG. 1, the server 50 is communication-connected to the indoor temperature controller 10 to transmit and receive specified signals. Meanwhile, as described in the embodiment of FIG. 2, the server 50 may be communication-connected to the heater 30 to transmit and receive specified signals. In this case, the server 50 may be a means for managing and controlling the heater 30 and/or the heating operation of the heater 30 based on information received from the indoor temperature controller 10 or the heater 30.

In addition, the server 50 may determine the insulation rating of the building based on the heating operation of the heater 30.

In this case, when receiving indoor temperature data from the indoor temperature controller 10 or the heater 30 every specified time unit, the server 50 stores the indoor temperature data. The indoor temperature data received from the indoor temperature controller 10 or the heater 30 every specified time unit may be expressed as shown in Table 1 below.

TABLE 1

| Time | Indoor temperature |
|---|---|
| t1 | 26° C. |
| t2 | 26° C. |
| t3 | 26° C. |
| t4 | 25° C. |
| t5 | 25° C. |
| t6 | 24° C. |
| . | . |
| . | . |
| . | . |

When the number of stored indoor temperature data reaches a specified number (N), the server 50 may store external environmental information at a corresponding time point, such as outdoor temperature, weather, time, and the like, corresponding to the indoor temperature data.

The server 50 may determine the insulation rating of a building or the building where the heater 30 is installed based on the stored indoor temperature data.

In this case, the server 50 identifies the time it takes for the indoor temperature to decrease by a reference temperature (a) based on the highest indoor temperature among the indoor temperature data. For example, when it is assumed that the maximum indoor temperature is T° C., the time it takes to decrease by a ° C. based on T° C. is checked.

The server 50 stores the time it takes for the indoor temperature to decrease by the reference temperature (a).

Based on the same outdoor temperature, the server 50 may classify and store information on the time that the indoor temperature decreases for each heater 30 as shown in Table 2 below.

TABLE 2

| Indoor temperature | Heater 1 | Heater 2 |
|---|---|---|
| T° C. −> (T − a)° C. | i1 | j1 |
| (T − a)° C. −> (T − 2a)° C. | i2 | j2 |
| (T − 2a)° C. −> (T − 3a)° C. | i3 | j3 |
| (T − 3a)° C. −> (T − 4a)° C. | i4 | j4 |
| (T − 4a)° C. −> (T − 5a)° C. | i5 | j5 |
| . | . | . |
| . | . | . |
| . | . | . |

As shown in Table 2, it takes heater 1 as much time as i1, and heater 2 as time as j1 to decrease from the highest temperature of T° C. by a° C. and reach (T-a)° C. In addition, it takes heater 1 as much time as i2 and heater 2 as much time as j2 to decrease from (T-a°) C by a° C. and reach (T-2a° C.) Likewise, it takes heater 1 as much time as i3 and heater 2 as much time as j3 to decrease from (T-2a°) C by a° C. and reach (T-3a° C.)

As described above, the server 50 may determine the insulation rating of the building in which the corresponding heater 30 is installed, based on the time it takes to decrease by the reference temperature (a) based on the highest temperature among the indoor temperature data. In this case, the server 50 may determine the insulation level as one of rating 1 to rating 10.

In this case, in a well-insulated building, because the indoor temperature falls slowly, it takes a long time for the indoor temperature to decrease by the reference temperature (a), whereas in a poorly insulated building, the indoor temperature falls quickly, so it takes a long time for the indoor temperature to decrease by the reference temperature (a).

Therefore, the server 50 may determine the insulation rating to be higher as the time it takes to decrease by the reference temperature (a) is longer.

The server 50 may store information on the determined insulation rating corresponding to each heater 30. In this case, when the server 50 is to determine the next insulation rating based on the insulation rating information corresponding to each heater 30, the server 50 may determine the next insulation rating based on the insulation rating previously determined corresponding to each heater 30 and a relative value.

For example, as shown in Table 3 below, the insulation rating corresponding to the first registered heater 1 may be as rating 5, which is the middle value among ratings 1 to 10. When following heater 2 is added, the insulation rating of heater 2 may be determined as rating 6 after relatively evaluating the decreasing time of the indoor temperature based on the insulation rating corresponding to heater 1.

TABLE 3

| Heater | Insulation rating |
|---|---|
| Heater 1 | 5 |
| Heater 2 | 6 |

When the server 50 stores information on the determined insulation rating corresponding to each heater 30, the server 50 may also store additional information about the building where the heater 30 is installed, such as the direction of the building, a number of floors, floor space types, and the like.

The server 50 may transmit information about the stored insulation rating to the indoor temperature controller 10 or the heater 30 so that it can be used for later heating control. In this case, the server 50 may transmit information about the insulation level when there is a request from a pre-registered terminal, that is, the indoor temperature controller 10 or the heater 30.

According to another embodiment, when the server 50 receives an auxiliary insulation rating determination mode entry signal from the indoor temperature controller 10 or the heater 30, the server 50 may count the number of times the heater 30 is turned on/off for a specified time period and determine the insulation rating of the heater based on the counted number of times.

The heater 300 may enter the auxiliary insulation rating determination mode while operating in the room temperature mode. When the indoor set temperature changes within a reference time while the heater 30 operates in the room temperature mode or the auxiliary insulation rating determination mode, the auxiliary insulation rating determination mode may be terminated.

When the heater 30 operates in the auxiliary insulation rating determination mode, the server 50 may receive a heater 30 ON signal or a heater 30 OFF signal from the indoor temperature controller 10 or the heater 30.

In this case, the server 50 starts counting the time after the heater 30 is turned off, and counts the number of times the heater 30 is turned on/off until the set time is reached.

In this case, the server 50 counts only the number of times the heater 30 is turned on/off based on the indoor set temperature, and does not count the number of times the heater 30 is turned on/off according to other conditions. For example, the server 50 does not count the number of times the heater 30 is turned on/off due to an increase or decrease in the supply water temperature or the return water temperature, the number of times the heater 30 is turned on/off due to the operation of an overheating protector, the number of times the heater 30 is turned on/off due to freeze prevention operation, and the like.

When a specified time elapses, the server 50 may determine the insulation rating of the building where the heater 30 is installed based on the number of times the heater 30 is turned on/off counted during the specified time.

In this case, because the indoor temperature drops slowly in well-insulated buildings, the number of times the heater 30 is turned on/off is small, whereas the indoor temperature drops quickly in poor insulated buildings, so that the number of times the heater 30 is turned on/off increases based on the same time period.

Accordingly, the server 50 may determine the insulation rating to be higher as the number of times the heater 30 is turned on/off counted during a specified time decreases. When determining the insulation rating, the server 50 determines the insulation rating after evaluating the insulation rating relative to the insulation ratings stored corresponding to other heaters 30.

The server 50 may store insulation rating information corresponding to the heater 30 installed in the building.

In this case, when the insulation rating information relates to the heater 30 having the same insulation rating as that previously determined based on the decreasing time of the indoor temperature, the server 50 may separately store the previously determined insulation rating information (insulation rating 1) and the insulation rating information (insulation rating 2) determined based on the number of times the heater 30 is turned on/off.

Likewise, the server 50 may transmit information about the stored insulation rating to the indoor temperature controller 10 or the heater 30 such that the information is used for later heating control. In this case, the server 50 may transmit information about the insulation rating when there is a request from a previously registered terminal, that is, the indoor temperature controller 10 or the heater 30.

In this case, the server 50 may be implemented as an independent hardware device including a memory and a processor that processes each operation, and may be driven as included in another hardware device such as a microprocessor or a general-purpose computer system.

Hereinafter, the operation flow of the system configured according to the present disclosure as described above will be described in more detail.

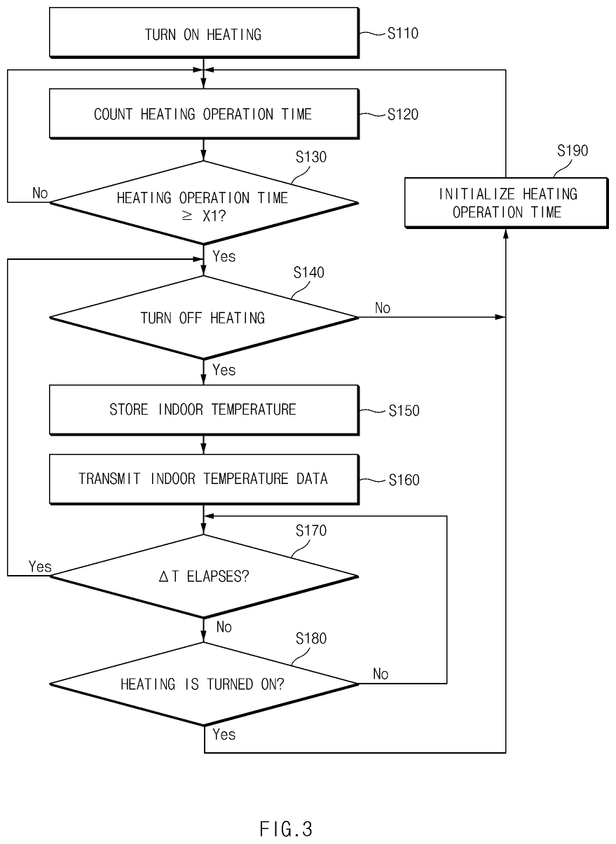

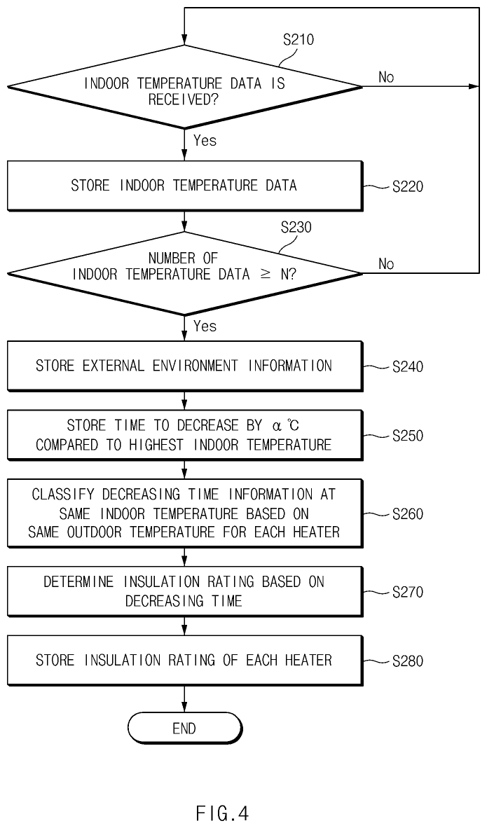

FIGS. 3 and 4 are flowcharts illustrating a method for determining the insulation rating of a heating system according to an embodiment of the present disclosure.

The embodiment of FIG. 3 illustrates the operation flow in the indoor temperature controller 10 or the heater 30. For convenience of description, although the following description will be based on the operation in the indoor temperature controller 10, the same operation may also be performed in the heater 30. The embodiment of FIG. 4 illustrates the operation flow in the server 50.

Referring to FIG. 3, when the heating operation of the heater 30 is turned on in S110, the indoor temperature controller 10 counts the heating operation time in S120.

When, in S130 and S140, the heating operation is not turned off until the heating operation time reaches a first time (X1), the indoor temperature controller 10 initializes the heating operation time in S190.

In this case, because the heating must be performed for more than a specified time period in order to determine the insulation rating based on the time for which the indoor temperature decreases, the operation of FIG. 3 in which the heating is turned off before the heating operation time reaches the first time (X1) may be terminated.

After the heating operation time reaches the first time (X1) in S130, when the heating is turned off in S140, the indoor temperature controller 10 stores the indoor temperature at the corresponding time point in S150. In this case, the indoor temperature controller 10 transmits the indoor temperature data stored in S150 to the server 50 in S160.

After the heating is turned off in S140, the indoor temperature controller 10 stores the indoor temperature every specified time (t) until the heating is turned on again in S150, and transmits it to the server 50 in S160.

When the heating is turned on again in S180 after the heating is turned off in S140, the indoor temperature controller 10 initializes the heating operation time in S190 and performs S120.

Referring to FIG. 4, when the indoor temperature data is received from the indoor temperature controller 10 through the process of FIG. 3 in S210, the server 50 stores the received indoor temperature data in S220. The server 50 may repeat operations S210 and S220 until the number of stored indoor temperature data reaches a specified number (N).

When the number of stored indoor temperature data reaches the specified number (N) in S230, the server 50 may store external environmental information at the corresponding time point, such as outdoor temperature, weather, time, and the like, corresponding to the indoor temperature data in S240.

Thereafter, in S250, the server 50 may identify and store the time it takes for the indoor temperature to decrease by the reference temperature (a) based on the highest indoor temperature among the indoor temperature data stored in S220.

In this case, the server 50 classifies the decreasing time information at the same indoor temperature for each heater 30 based on the same outdoor temperature in S260, and in S270, determines the insulation rating of the building where the heater 30 is installed based on the decreasing time of the indoor temperature for each heater 30 classified in S260.

In S270, the server 50 may determine the insulation rating to be higher as the time it takes to decrease by the reference temperature (a) increases.

In S280, the server 50 may store the insulation rating information determined in S270 corresponding to each heater 30.

Although not shown in FIG. 4, when there is a request from the indoor temperature controller 10, the server 50 may provide the insulation rating information stored corresponding to the corresponding heater 30 in S280 to the indoor temperature controller 10.

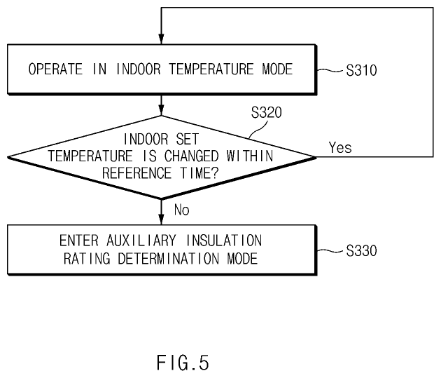

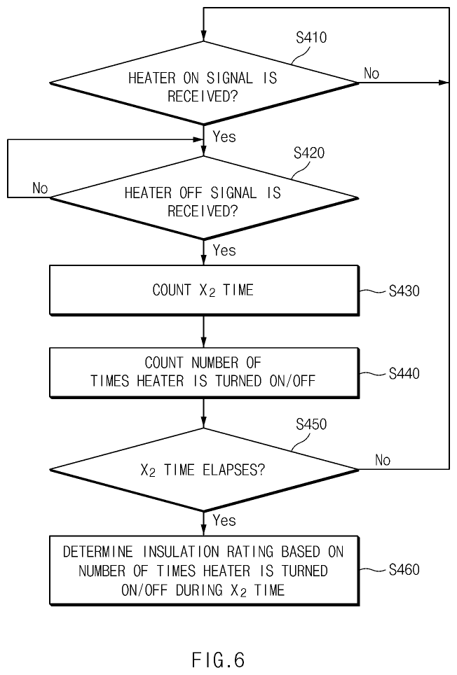

FIGS. 5 and 6 are flowcharts illustrating a method for determining an insulation rating of a heating system according to another embodiment of the present disclosure.

The embodiment of FIG. 5 illustrates the operation flow in the indoor temperature controller 10 or the heater 30. For convenience of description, although the following description will be based on the operation in the indoor temperature controller 10, the same operation may also be performed in the heater 30. The embodiment of FIG. 6 illustrates the operation flow in the server 50.

Referring to FIG. 5, when the indoor set temperature is changed within a reference time while the heater 30 operates in the indoor temperature mode, in S310 and S320, the indoor temperature controller 10 may operate in the indoor temperature mode based on the changed indoor temperature.

Meanwhile, when the indoor set temperature does not change within the reference time while operating in the indoor temperature mode in S320, the indoor temperature controller 10 enters the auxiliary insulation rating determination mode in S330. In this case, the indoor temperature controller 10 may transmit a signal notifying entry into the auxiliary insulation rating determination mode to the server 50. The indoor temperature controller 10 continues to perform heating control operations based on the indoor set temperature even after entering the auxiliary insulation rating determination mode. In this case, when the heater 30 is turned on or off, the indoor temperature controller 10 may transmit an ON signal or an OFF signal of the heater 30 to the server 50.

Referring to FIG. 6, when the server 50 identifies entry into the auxiliary insulation rating determination mode from the indoor temperature controller 10, the server 50 counts the number of times the heater 30 is turned on/off.

In this case, after the server 50 first receives the ON signal of the heater 30 in S410, when the OFF signal of the heater 30 is received in S420, in S430, the time is counted until the time reaches the second time (X2).

Thereafter, in S440, the server 50 counts the number of times the heater 30 is turned on/off. In this case, the server 50 repeatedly performs operations S410 to S440 until the second time (X2) elapses and counts the number of times the heater 30 is turned on/off.

In S440, the server 50 counts only the number of times the heater 30 is turned on/off based on the indoor set temperature, and does not count the number of times the heater 30 is turned on/off according to other conditions. For example, the server 50 does not count the number of times the heater 30 is turned on/off due to an increase or decrease in the supply water temperature or the return water temperature, the number of times the heater 30 is turned on/off due to the operation of an overheating protector, the number of times the heater 30 is turned on/off due to freeze prevention operation, and the like.

When the second time (X2) elapses, in S460, the server 50 determines the insulation rating of the building where the heater 30 is installed based on the number of times the heater 30 is turned on/off counted for the second time (X2).

In S460, the server 50 may determine the insulation rating to be higher as the number of times the heater 30 is turned on/off counted for a specified time decreases.

Although not shown in FIG. 6, when there is a request from the indoor temperature controller 10, the server 50 may provide the insulation rating information determined in S460 to the indoor temperature controller 10.

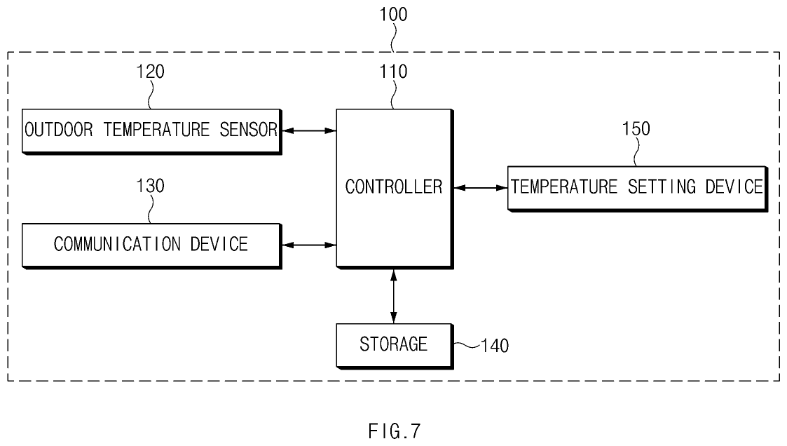

FIG. 7 is a block diagram illustrating the configuration of a device for controlling a set heating temperature according to an embodiment of the present disclosure.

A device 100 for controlling a set heating temperature according to an embodiment of the present disclosure may be implemented as an independent hardware device including a memory and a processor that processes each operation, and may be driven as included in another hardware device such as a microprocessor or a general-purpose computer system.

In this case, the device 100 for controlling a set heating temperature, which is an independent device, may be communication-connected to at least one of the indoor temperature controller 10, the heater 30, or the server 50 of the heating system to transmit set heating temperature data.

Meanwhile, the device 100 for controlling a set heating temperature may be included in one of the indoor temperature controller 10, the heater 30, or the server 50 of the heating system.

Referring to FIG. 3, the device 100 for controlling a set heating temperature may include a controller 110, an outdoor temperature sensor 120, a communication device 130, storage 140, and a temperature setting device 150.

The controller 110 may be a hardware device such as a processor or central processing unit (CPU), or a program implemented by a processor. The controller 110 may be connected to each component of the device 100 for controlling a set heating temperature to perform the overall function of the device 100 for controlling a set heating temperature.

The outdoor temperature sensor 120 may detect the outdoor temperature and provide the detected outdoor temperature to the controller 110. In this case, the outdoor temperature may be used to determine the set heating temperature.

The communication device 130 may be communication-connected to at least one of the indoor temperature controller 10, the heater 30, and the server 50 of the heating system to transmit and receive signals. In this case, the communication device 130 is communication-connected to the server 50 to receive the insulation rating information of the building in which the heater 30 is installed from the server 50. In addition, the communication device 130 may be communication-connected to the indoor temperature controller 10 or the heater 30 to transmit the set heating temperature determined based on the insulation rating and the outdoor temperature.

In addition, the communication device 130 may transmit guidance information about the finally determined set heating temperature to the indoor temperature controller 10 installed in the indoor space where the user is located.

In addition, the communication device 130 may receive outdoor temperature information from one of components of a communication-connected heating system. In this case, the outdoor temperature sensor 120 provided in the device 100 for controlling a set heating temperature may be omitted.

The storage 140 may store data and/or algorithms necessary for the device 100 for controlling a set heating temperature to operate.

As an example, the storage 140 may determine the temperature setting factor value according to the insulation rating information received from the server 50, or store a command and/or an algorithm for determining the temperature setting factor value by reflecting the insulation rating information. In addition, the storage 140 may store a command and/or an algorithm for determining the set heating temperature corresponding to the outdoor temperature based on the temperature setting factor value.

In this case, the storage 140 may include storage media such as a random access memory (RAM), a static random access memory (SRAM), a read-only memory (ROM), a programmable read-only memory (PROM), and an electrically erasable programmable read-only memory (EEPROM).

The controller 110 determines the temperature setting factor value according to the insulation rating information received from the server that manages the insulation rating information of the building in which the heater is installed.

The controller 110 may determine the temperature setting factor value based on a data table in which the temperature setting factor value according to the insulation rating is defined.

In this case, the controller 110 may determine the temperature setting factor value based on the default value of the temperature setting factor, the predefined reference insulation rating, and the insulation rating information of the corresponding building received from the server 50. The default value of the temperature setting factor and reference insulation rating may be defined in advance, and it may be natural that they are not fixed values but can be applied in various manners depending on the condition of the building, or the like.

In this case, the temperature setting factor value determined by the controller 110 may be reflected in determining the set heating temperature according to the outdoor temperature.

Because the heating efficiency of a building may vary depending on the insulation rating, it is possible to determine the set heating temperature optimized for heating control by determining the temperature setting factor value reflected in determining the set heating temperature based on the insulation rating of the building where the heater 30 is installed.

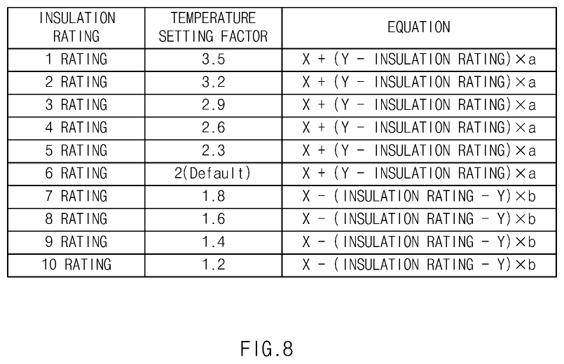

Refer to FIG. 8 for an embodiment of determining the temperature setting factor value based on the insulation rating information received from the server 50.

Referring to FIG. 8, when the insulation rating is classified into ratings 1 to 10, the controller 110 may determine the temperature setting factor value for each of the insulation ratings by using Equation 1 and Equation 2 below.

In this case, when the insulation rating of the building is lower than or equal to the reference insulation rating, the controller 110 may determine the temperature setting factor value based on the value obtained by subtracting the insulation rating of the building from the reference insulation rating, as expressed as Equation 1.

Meanwhile, when the insulation rating of the building is higher than the reference insulation rating, the controller 110 may determine the temperature setting factor value based on the value obtained by subtracting the reference insulation rating from the insulation rating of the building, as expressed as Equation 2.

As an example, when it is assumed that the reference insulation rating is rating 6, the controller 110 may determine the temperature setting factor value for each insulation rating by using Equation 1 for corresponding buildings having insulation ratings 1 to 6.

$$F = X + ( Y - Insulation rating ) Sa \qquad [ Equation 1 ]$$

In Equation 1, ‘F’ represents the temperature setting factor value, ‘X’ represents the default value of the temperature setting factor, ‘Y’ represents the reference insulation rating, and ‘a’ represents an arbitrary first constant. For example, the default value of the temperature setting factor may be 2, the reference insulation rating may be defined as rating 6, and the first constant may be defined as 0.3.

Referring to Equation 1, when the insulation rating of a building is rating 1, the temperature setting factor value is ‘F=2+(6−1)×0.3=3.5’. When the insulation rating is 2, the temperature setting factor value is ‘F=2+(6−2)×0.3=3.2’. In addition, when the insulation rating of the building is rating 3, the temperature setting factor value is ‘F=2+(6−3)×0.3=2.9’, and when the insulation rating of the building is rating 4, the temperature setting factor value is ‘F=2+(6−4)×0.3=2.6’. In addition, when the insulation rating of the building is rating 5, the temperature setting factor value is ‘F=2+(6−5)×0.3=2.3’, and when the insulation rating of the building is rating 6, the temperature setting factor value is ‘F=2+(6−6)×0.3=2’.

Meanwhile, the controller 110 may determine the temperature setting factor value for each of insulation ratings by using Equation 2 for buildings having insulation ratings 7 to 10.

$$F = X - ( Insulation rating - Y ) Sb \qquad [ Equation 2 ]$$

Where ‘F’ represents the temperature setting factor value, ‘X’ represents the default value of the temperature setting factor, ‘Y’ represents the reference insulation rating, and ‘b’ represents an arbitrary second constant. For example, the default value of the temperature setting factor may be 2, the reference insulation rating may be defined as rating 6, and the second constant may be defined as 0.2.

Referring to Equation 2, when the insulation rating of the building is 7, the temperature setting factor value is ‘F=2−(7−6)×0.2=1.8’, and when the insulation rating of the building is 8, the temperature setting factor value is ‘F=2−(8−6)×0.2=1.6’. In addition, when the insulation rating of the building is rating 9, the temperature setting factor value is ‘F=2−(9−6)×0.2=1.4’, and when the insulation rating of the building is rating 10, the temperature setting factor value is ‘F=2−(10−6)×0.2=1.2’.

Of course, a variable value and a constant value applied to Equation 1 and Equation 2 are only one example and are not fixed to specific values, and may change according to an embodiment.

As described above, the controller 110 may determine the temperature setting factor value based on the insulation rating information received from the server 50.

The controller 110 stores the determined temperature setting factor value in the storage 140 and provides information about the stored temperature setting factor value to the temperature setting device 150.

When the temperature setting factor value is received from the controller 110, the temperature setting device 150 determines the set heating temperature based on the temperature setting factor value.

In this case, the temperature setting device 150 may determine the set heating temperature based on a temperature change graph in which the outside air temperature and the set heating temperature are defined for each temperature setting factor.

Refer to the embodiment of FIG. 5 for the temperature change graph defined for each temperature setting factor.

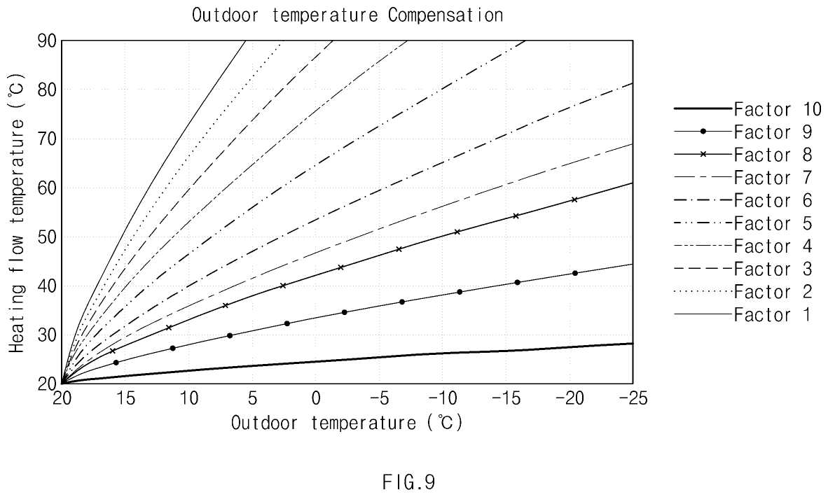

Referring to FIG. 9, when the insulation rating is classified into ratings 1 to 10, the temperature setting factor values corresponding to ratings 1 to 10 may be defined as Factor 1, Factor 2, Factor 3, . . . , Factor 10.

In this case, in the temperature change graph for each temperature setting factor, a set heating temperature that changes corresponding to the outdoor temperature may be defined.

Therefore, when the temperature setting factor value is determined by the controller 110, the temperature setting device 150 may determine the set heating temperature corresponding to the outdoor temperature from the temperature change graph defined based on the determined temperature setting factor value.

As an example, when it is assumed that the temperature setting factor value determined by the controller 110 is Factor 6, the temperature setting device 150 may determine the set heating temperature corresponding to the outdoor temperature in the temperature change graph defined based on Factor 6 in FIG. 5.

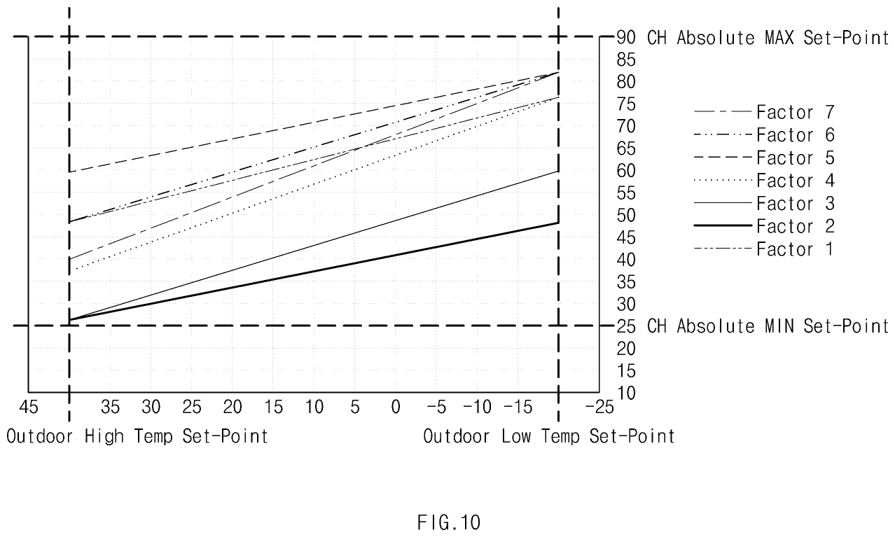

FIG. 10 is a temperature change graph for each temperature setting factor according to another embodiment. The temperature setting device 150 may determine the set heating temperature corresponding to the outdoor temperature with reference to FIG. 6.

Of course, the temperature change graph for each temperature setting factor is not limited to FIGS. 9 and 10, and it is natural that various modifications can be made depending on an embodiment.

The set heating temperature determined by the temperature setting device 150 reflects not only the outdoor temperature but also the insulation rating information for the corresponding building.

Accordingly, the controller 110 may set the control temperature of the heater 30 based on the set heating temperature determined by the temperature setting device 150.

The controller 110 may provide information about the set heating temperature to the user without directly setting the control temperature of the heater 30 based on the set heating temperature. In this case, the user may set the control temperature of the heater 30 based on the information about the guided set heating temperature.

In this case, when the device 100 for controlling a set heating temperature is included in the server 50 or is implemented as a separate device, the information on the set heating temperature determined by the temperature setting device 150 may be transmitted to the indoor temperature controller 10 or the heater 30.

Hereinafter, the operation flow of the device configured according to the present disclosure as described above will be described in more detail.

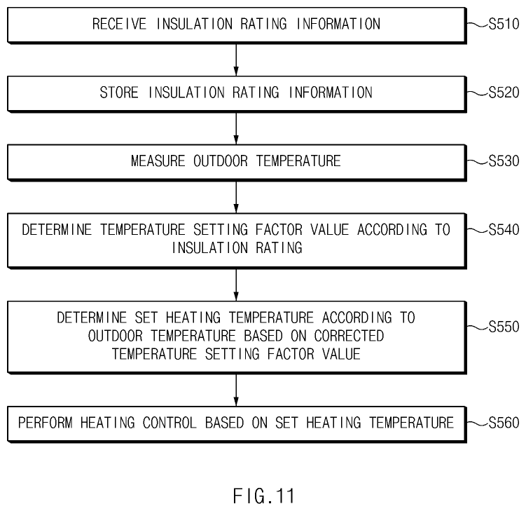

FIG. 11 is a flowchart illustrating a method for controlling a set heating temperature according to an embodiment of the present disclosure.

Referring to FIG. 11, when the device 100 for controlling a set heating temperature receives the insulation rating information of the building where the heater 30 is installed from the server 50 for efficient heating control of the heater 30 in S510, in S520, the device 100 for controlling a set heating temperature stores the received insulation rating information received in S510.

In this case, the device 100 for controlling a set heating temperature may separately request insulation rating information of the building in which the corresponding heater 30 is installed from the server 50 before performing S510.

In addition, in S530, the device 100 for controlling a set heating temperature may measure the outdoor temperature by using the outdoor temperature sensor 120.

Thereafter, in S540, the device for controlling a set heating temperature determines the temperature set factor value based on the insulation rating information stored in S520. For a detailed description of the operation of determining the temperature setting factor value in S540, refer to the embodiment of FIG. 8.

In S550, the device 100 for controlling a set heating temperature may determine the optimal set heating temperature applicable to the heater 30 based on the temperature setting factor value determined in S540. In S550, the device 100 for controlling a set heating temperature may determine the set heating temperature corresponding to the outdoor temperature on a temperature change graph defined based on the temperature setting factor value determined in S540.

When the set heating temperature is determined through S550, in S560, the device 100 for controlling a set heating temperature may perform heating control based on the determined set heating temperature. In S560, the device 100 for controlling a set heating temperature may perform heating control by setting the control temperature of the heater 30 based on the set heating temperature.

In this case, the device 100 for controlling a set heating temperature may guide information about the set heating temperature to the user before S560. In this case, the user may set the control temperature of the heater 30 based on the information about the guided set heating temperature.

As described above, according to the embodiments of the present disclosure, it is possible to determine the actual insulation rating of the building where the heater 30 is installed, so that the insulation rating information of the building may be used for later heating control.

In addition, according to the embodiments of the present disclosure, when setting the temperature for heating control of the heater 30, the set heating temperature is determined by reflecting the insulation rating and outdoor temperature of the building where the heater 30 is installed, so that it is possible to perform heating control with higher efficiency.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

1. A heating system comprising:
a heater configured to heat an entire or specified indoor space;
an indoor temperature controller configured to control a heating operation of the heater; and
a server configured to determine an insulation rating of a building in which the heater is installed, based on indoor temperature data received from the indoor temperature controller or the heater.

2. The heating system of claim 1, wherein the server is configured to receive and store indoor temperature data every specified time period when the heater is turned off after being operated for a first time period.

3. The heating system of claim 2, wherein the server is configured to store information about a time taken for an indoor temperature to decrease by a reference temperature based on a highest indoor temperature among the indoor temperature data when the stored indoor temperature data reaches a specified number.

4. The heating system of claim 3, wherein the server is configured to classify information about a time taken for a same indoor temperature to decrease by the reference temperature based on a same outdoor temperature for each heater, and determine an insulation rating of a building in which a corresponding heater is installed, based on a classified decreasing time of an indoor temperature for each heater.

5. The heating system of claim 4, wherein the server is configured to determine the insulation rating to be higher as the time taken for the indoor temperature to decrease by the reference temperature increases.

6. The heating system of claim 4, wherein the server is configured to determine the insulation rating of the building in which the corresponding heater is installed after relatively evaluating the time taken for the indoor temperature to decrease by the reference temperature based on an insulation rating corresponding to an initially registered heater.

7. The heating system of claim 1, wherein the heater is configured to enter an auxiliary insulation rating determination mode when there is no change in indoor set temperature during a reference time in an indoor temperature mode.

8. The heating system of claim 7, wherein the server is configured to:
count a number of times the heater turned on/off during a second time period when the heater enters the auxiliary insulation rating determination mode, and
determine the insulation rating of the building in which the heater is installed based on the number of times the heater is turned on/off during the second time period.

9. The heating system of claim 8, wherein the server is configured to determine the insulation rating of the building in which the heater is installed to be higher as the number of on/off times of the heater counted during the second time decreases.

10. The heating system of claim 1, wherein the server is configured to store information on the insulation rating determined for the building where the heater is installed and provide the information on the insulation rating for the building when requested.

11. A method of determining an insulation rating of a heating system, the method comprising:
receiving, by a server, indoor temperature data every specified time period from a heater configured to heat an entire or specified indoor space or an indoor temperature controller configured to control a heating operation of the heater; and
determining, by the server, an insulation rating of a building in which the heater is installed, based on the indoor temperature data received every specified time period.

12. The method of claim 11, wherein the determining of the insulation rating includes:
storing information about a time taken for an indoor temperature to decrease by a reference temperature based on a highest indoor temperature among the indoor temperature data when the indoor temperature data reaches a specified number;
classifying information about a time taken for a same indoor temperature to decrease by the reference temperature based on a same outdoor temperature for each heater; and
determining an insulation rating of a building in which a corresponding heater is installed, based on a classified decreasing time of an indoor temperature for each heater.

13. The method of claim 11, further comprising:
entering, by the heater, an auxiliary insulation rating determination mode when there is no change in indoor set temperature during the reference time in an indoor temperature mode.

14. The method of claim 13, further comprising:
counting a number of times the heater turned on/off during a second time period when the heater enters the auxiliary insulation rating determination mode; and
determining the insulation rating of the building in which the heater is installed based on the number of times the heater is turned on/off during the second time period.

15. A device for controlling a set heating temperature, the device comprising:
a controller configured to determine a temperature setting factor value based on insulation rating information received from a server that manages the insulation rating information of a building in which a heater is installed; and
a temperature setting device configured to determine the set heating temperature corresponding to an outdoor temperature based on the determined temperature setting factor value.

16. The device of claim 15, wherein the controller is configured to determine the temperature setting factor value based on a default value of the temperature setting factor, a predefined reference insulation rating, and an insulation rating of a corresponding building.

17. The device of claim 16, wherein the controller is configured to:
determine the temperature setting factor value based on a value obtained by subtracting the insulation rating of the building from the reference insulation rating when the insulation rating of the building is lower than or equal to the reference insulation rating; and
determine the temperature setting factor value based on a value obtained by subtracting the reference insulation rating from the insulation rating of the building when the insulation rating of the building is higher than the reference insulation rating.

18. The device of claim 15, wherein the temperature setting device is configured to determine the set heating temperature corresponding to the outdoor temperature based on a temperature change graph defined corresponding to the determined temperature setting factor value.

19. The device of claim 15, further comprising:
a communication device configured to transmit the determined set heating temperature to an indoor temperature controller installed in an indoor space where a user is located.

20. The device of claim 15, further comprising:
storage configured to store the insulation rating information received from a server that manages the insulation rating information for the building in which the heater is installed.
